(19) United States
(12) Patent Application Publication
(10) Pub. No.: US 2022/0372755 A1
(43) Pub. Date: Nov. 24, 2022

(54) A METHOD OF REDUCING SHRINKAGE IN THE PRODUCTION OF STRUCTURAL PANELS FOR A BUILDING

(71) Applicant: Charles Caulder BREE, Mercer (IL)

(72) Inventor: Charles Caulder BREE, Mercer (IL)

(21) Appl. No.: 17/641,439

(22) PCT Filed: Aug. 7, 2020
(86) PCT No.: PCT/NZ2020/050085

§ 371 Date: Mar. 9, 2022

(30) Foreign Application Priority Data
Sep. 9, 2019 (NZ) 757092

(51) Int. Cl. E04C 2/20; E04C 2/292; E04B 2/00

(52) U.S. Cl. CPC E04C 2/205; E04C 2/292; E04C 2/46

(57) ABSTRACT

It is known that panels moulded for structural use can be subject to undesirable levels of shrinkage and this can complicate their end use or a building made from them. It is an object of the invention to go at least some way to addressing this problem. Accordingly there is provided a method of significantly reducing panel shrinkage in the production of a structural building panel. The method involves spraying polyurethane foam onto a rigid open mould such that the foam substantially embeds mesh, which prevents or significantly reduces shrinkage of the polyurethane foam. A skin of polyurea is then sprayed over the polyurethane to enhance structural strength of the panel.

### FIELD OF INVENTION

A preferred form of this invention relates to a method of reducing panel shrinkage in the context of forming structural panels for use in a building.

### BACKGROUND

It is known to form panels from synthetic polymers and the like. They are primarily used for exterior cladding over framing, or as a non-structural aesthetic finishing for the interior of buildings. The inventor has discovered that panels moulded for structural use can be subject to undesirable levels of shrinkage and this can complicate their end use or compromise a building made from them.

### OBJECT OF THE INVENTION

It is an object of the present invention to go at least some way to addressing the above shrinkage problem.

### INTERPRETATION

The term “comprising” or derivatives thereof such as “comprises” when used in this document in relation to a combination of features should not be interpreted exclusively. In other words the terms refer to the minimum features present, without ruling out the option of additional unspecified features. The ‘features’ may for example be physical items and/or action steps.

### SUMMARY OF THE INVENTION

According to one aspect of the invention there is provided a method of substantially reducing shrinkage in the production of a structural panel for use in a building, comprising:
spraying polyurethane foam onto a rigid open mould so that the foam substantially embeds mesh and such that the mesh prevents or at least significantly reduces shrinkage of the polyurethane foam; and
spraying a skin of polyurea over the polyurethane to enhance structural strength of the panel.

Optionally a first layer of the polyurethane foam is sprayed onto the mould, the mesh is laid against the first layer, and a second layer of the polyurethane foam is sprayed onto the first layer to substantially encase the mesh.

Optionally the first layer makes up approximately 70% ±10%, and the second layer makes up approximately 30% ±10%, of the thickness of the panel.

Optionally the first layer is approximately 70 mm thick ±20%, and the second layer is approximately 30 mm thick ±20%.

Optionally the mesh is metallic, eg steel, and is formed from strands that are 3-8 mm thick (eg in diameter).

Optionally the mesh is formed from strands that are approximately 4 mm thick (eg in diameter).

Optionally the mould is such that the panel curves from bottom to top.

Optionally the panel provides a structural wall section and a structural roof section for a building.

Optionally the mould is such that the panel is substantially straight or planar from bottom to top.

Optionally the panel is combined with other same or substantially similar panels, butted side to side, to form a building.

Optionally the building panel has an R rating of approximately 2 m²K/W per 50 mm thickness.

Optionally the polyurethane used, or used for each layer if applicable on the claim dependency, has a density of 25-200 kg/m³.

Optionally the polyurethane used, or used for each layer if applicable on the claim dependency, has a density of approximately 32 kg/m³.

Optionally shrinkage of the polyurethane foam is no more than 0-2% by 3 months. Optionally shrinkage of the polyurethane foam is no more than 0.01% by 3 months.

### DRAWINGS

Some preferred embodiments of the invention will now be described by way of example and with reference to the accompanying drawings, of which:

FIG. 1 illustrates a cross-section through a mould and part completed panel;

FIG. 2 illustrates the mould and panel at a more advanced stage of formation of the panel;

FIG. 3 is an isometric view of a completed panel, formed as per FIGS. 1 and 2;

FIG. 4 is a cross-sectional view of the completed panel;

FIG. 5 is an isometric view of a building formed by combining a series of the panels;

FIG. 6 is a vertical cross section of a portion of the building showing how the panel may be fitted to a foundation or floor;

FIG. 7 is a vertical cross section of a portion of the building showing how the panel may be fitted to a foundation or floor in an alternative manner;

FIG. 8 is a horizontal cross section through a portion of the building showing how neighbouring panels may be secured to one another.

### DETAILED DESCRIPTION

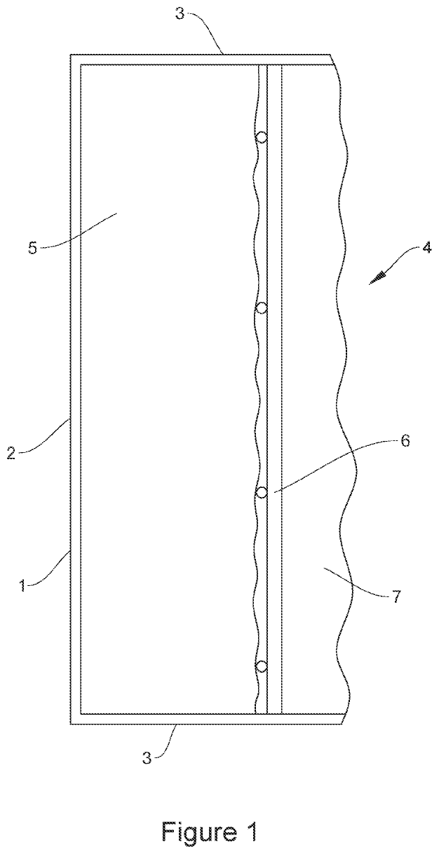

Referring to FIG. 1, a rigid metallic mould 1, in this case made of steel, is formed in the shape of a structural building panel. The mould 1 has a base 2, side walls 3 and an open front 4. The mould is shown standing upright, but in use it may be laying on its base 2.

With further reference to FIG. 1, a first layer 5 of foam, eg polyurethane foam, is sprayed into the mould and hardens in less than one minute. The first layer may for example be about 70 mm thick ±20%. Metallic mesh 6, substantially rigid and made from welded galvanised steel rods 3-8 mm thick, preferably about 4 mm thick, is laid over the first layer 5. The rods are such that they have been welded together at each crossing/intersection that makes up the mesh. The mesh openings may be substantially square or some other shape, and about 150-250 mm across, preferably about 200 mm across. A second layer 7 of polyurethane foam, the same or different, is then sprayed over the first layer 5 and mesh 6 so that the mesh is encased about where the two layers meet. The second layer 7 also hardens in less than one minute. The second layer 7 may be about 30 mm thick ±20%. In some instances each of the two layers may be built up from a series of thinner sub-layers, but are still referred to as ‘first’ and ‘second’ layers to distinguish the polyurethane either side of the mesh 6.

The thickness of the first and second layers may be other than 70 mm and 30 mm respectively, although preferably this approximate ratio is maintained regardless of the combined thickness of the two layers. The combined thickness may for example be from 90-300 mm depending on the desired heat insulation and overall strength requirements for the finished panel.

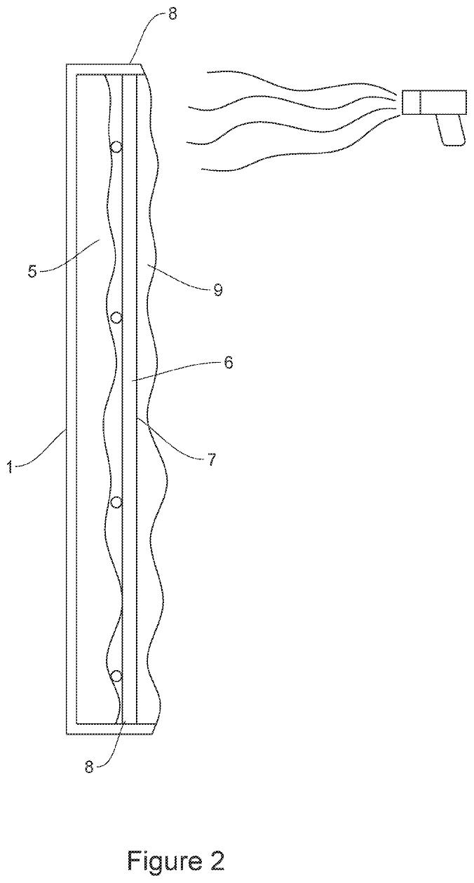

Referring to FIG. 2, optionally the mesh 6 is arranged to protrude slightly at the top and/or bottom of the first and second layers of polyurethane as indicated at 8. The protruding mesh at the bottom can be used to conveniently tie the panel to a floor or foundation when forming a building. The protruding mesh at the top can be used to fasten a roof cap and/or to assist in joining the top of the panel to neighbouring panels the same or similar, when forming a building.

With further reference to FIG. 2, a skin, preferably a polyurea skin 9, is sprayed completely over and around the two layers of polyurethane 5, 7. The polyurea skin 9 may be applied to the second layer 7 of polyurethane while still in the mould 1, with further spray application of polyurea skin to envelope the other polyurethane surfaces after removal from the mould. Alternatively the polyurea skin 9 may be applied to all of the polyurethane surfaces after removal from the mould. The polyurea skin wraps completely around the polyurethane to enhance the strength of the panel. The skin may for example be 2-6 mm thick, but is preferably about 2 mm thick.

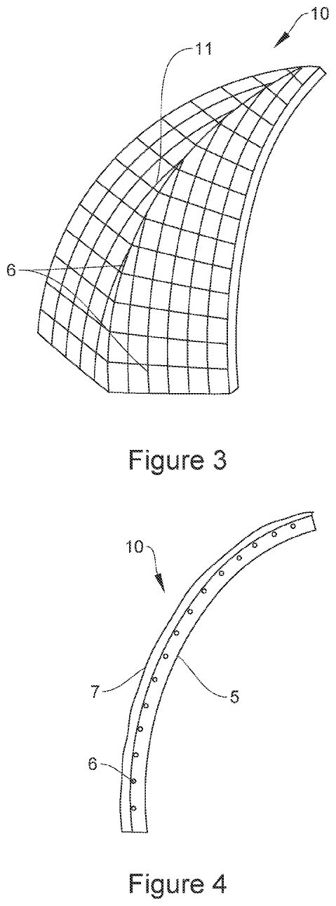

FIGS. 3 and 4 show the completed panel 10. In FIG. 3 the mesh 6 is illustrated for ease of understanding, although in reality it would be within the rest of the panel and therefore not visible. As shown in FIG. 3, the panel 10 is formed to have a corner ridge 11 to enhance strength, although this is not essential. In alternative embodiments the completed panel may be straight or flat over its entire length and width.

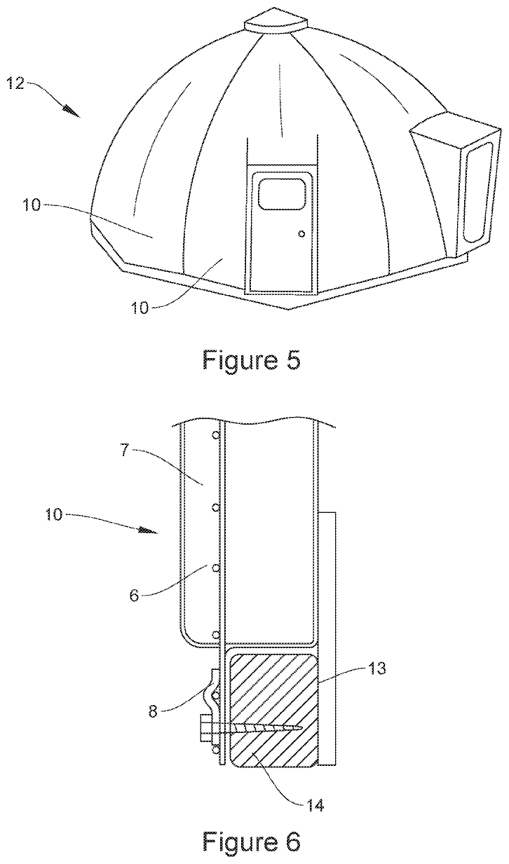

FIG. 5 illustrates a building 12 formed from a series of the panels 10. More specifically, the building 12 is formed by butting a series of the panels 10 together. The panels 10 are fastened to one another at their side edges with glue and/or screw or other pin type fasteners. The edges may be ‘stepped’ complimentarily, so that immediately neighbouring panels overlap one another. The building 12 is generally hexagonal in its footprint, but in other embodiments it may an alternative shape.

The mesh serves to prevent or at least significantly reduce shrinkage of the polyurethane in the panel 10 over the days, weeks and months after its completion. This is important because it enables panels to be produced in a size-reliable manner so that shrinkage does not compromise the building they are for. It has been found that shrinkage is more prone at the outside surface of a building when formed as above, which is why the mesh is preferably positioned nearer the outside surface of the panel than its interior surface. In addition to addressing shrinkage, having the imbedded mesh 6 serves to enhance security in that the panels/building walls are more difficult for a would-be intruder to cut through. The mesh may also enhance the strength of the building generally.

FIG. 6 illustrates one option for securing the panels 10 to the building's 12 floor or foundation 13. As shown, the mesh 6 that protrudes 8 at the bottom of the panel is screw fastened to a beam 14 that forms part of the foundation.

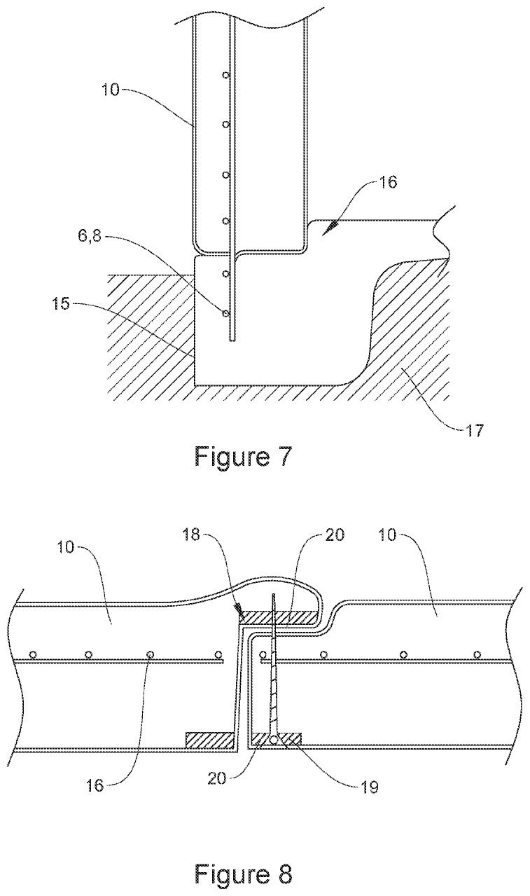

FIG. 7 illustrates an alternative way of attaching the panels 10 to the building's 12 floor or foundation, for example when the foundation or floor is a poured or sprayed concrete or other pad 15. In this case the portion of the mesh 6, 8 that protrudes at the bottom of the panel is cast into the pad 15. As also shown, the panel sits in a complimentary shaped step 16 at the edge of the pad to assist in providing accurate placement of parts. The ground is indicated at 17.

FIG. 8, which is a horizontal section through a portion of the building 12, illustrates the manner in which the panels 10 may be secured to one another along their upright sides or edges. As shown, the panels 10 butt one another at complimentary steps 18 and are fastened to one another at such steps by way of screws 19 and/or glue. The steps 18 incorporate moulded-in beam like strips 20 to give the screws 19 better purchase for a secure connection between adjoining panels. The strips 20 may be wooden or any other suitable material. The joins between the edges of the panels may be sprayed over with a polyurea skin for enhanced strength and water-tightness.

The polyurethane foam in each case above may for example be the product Endurathane SR42M available from the supplier Polymer Group Ltd which has a website at www.Polymer.co.nz.

The polyurea skin in each case above may for example be the product Endurathane P515, also available from the supplier Polymer Group Ltd which has a website at www.Polymer.co.nz.

Preferably the panels each have a foam density of 32 kg/m³. In some preferred embodiments they may have a density of from 25 to 200 kg/m³.

Preferably the panels have an insulation New Zealand ‘R’ rating of about 2.05 m² K/W for every 50 mm. The preferred the ‘R’ rating of each finished panel may optionally be from 1.5 to 6 depending on how thick it is.

Preferably panels formed as above exhibit less than 1% shrinkage at 3 months after their completion, and more preferably no more than about 0.01% shrinkage by 3 months. Optionally the shrinkage may be no more than 0% to 2% by 3 months.

Preferably the panels are structural in that they need no framework strengthening, for example they do not need any upright beams or framing to make them load bearing.

The strips 20 for the screws to gain purchase are not load bearing, preferably they are approximately 9 mm to approximately 15 mm thick, and most preferably approximately 12 mm thick. The strips are preferably flexible so as to bend with curvature in the panel. They may be formed from plywood. They preferably bond into to the sprayed polyurethane.

In terms of disclosure, this document hereby anticipates and disclosures any feature mentioned herein in combination with any one or more other features mentioned herein, even if such combination is not the subject of a claim.

While some preferred forms of the invention have been described by way of example it should be understood that modifications and improvements can occur without departing from the scope of the following claims.

1. A method of substantially reducing shrinkage in the production of a structural panel for use in a building, comprising:
spraying polyurethane foam onto a rigid open mould so that the foam substantially embeds mesh and such that the mesh prevents or at least significantly reduces shrinkage of the polyurethane foam; and
spraying a skin of polyurea over the polyurethane to enhance structural strength the panel.

2. A method according to claim 1, wherein a first layer of the polyurethane foam is sprayed onto the mould, the mesh is laid against the first layer, and a second layer of the polyurethane foam is sprayed onto the first layer to substantially encase the mesh.

3. A method according to claim 2, wherein the first layer makes up approximately 70% ±10%, and
the second layer makes up approximately 30% ±10%, of the thickness of the panel.

4. A method according to claim 2, wherein the first layer is approximately 70 mm thick ±20%, and
the second layer is approximately 30 mm thick ±20%.

5. A method according to claim 1, wherein the mesh is metallic and is formed from strands that are 3-8 mm thick.

6. A method according to claim 1, wherein the mesh is formed from strands that are approximately 4 mm thick.

7. A method according to claim 1, wherein the mould is such that the panel curves, or is straight, from bottom to top.

8. A method according to claim 1, wherein the panel is formed to provide a structural wall section and a structural roof section for a building.

9. A building comprising panels, each panel formed according to the method of claim 1 , the panels being butted side to side and secured there.

10. A building panel formed according to the method of claim 1, having an R rating of approximately 2 m²K/W per 50 mm thickness.

11. A building comprising panels, each panel formed according to the method of claim 1, wherein the polyurethane used has a density of 25-200 kg/m³.

12. A building according to claim 11, wherein the polyurethane used, has a density of approximately 32 kg/m³.

13. A building according to claim 11, wherein shrinkage of the polyurethane foam is no more than 0-2% by 3 months.

14. A building according to claim 13, wherein shrinkage of the polyurethane foam is no more than 0.01% by 3 months.
